(19) United States
(12) Patent Application Publication
(10) Pub. No.: US 2017/0272857 A1
(43) Pub. Date: Sep. 21, 2017

(54) Device and Method for Calculating Excursion of Diaphragm of Loudspeaker and Method for Controlling Loudspeaker

(71) Applicant: REALTEK SEMICONDUCTOR CORPORATION, HSINCHU (TW)

(72) Inventors: WEI-CHUNG TING, HSINCHU COUNTY (TW); TSE-EN LIN, NEW TAIPEI CITY (TW); CHUNG-SHIH CHU, HSINCHU CITY (TW); TIEN-CHIU HUNG, NEW TAIPEI CITY (TW)

(21) Appl. No.: 15/433,606

(22) Filed: Feb. 15, 2017

(30) Foreign Application Priority Data
Mar. 15, 2016 (TW) 105107898

(51) Int. Cl. H04R 3/00; H04R 29/00

(52) U.S. Cl. CPC H04R 3/007; H04R 29/001

(57) ABSTRACT

A method for calculating excursion of a diaphragm of a loudspeaker is provided. The loudspeaker includes a diaphragm and is driven by a voltage signal. The method includes: a) low-pass filtering the voltage signal and a current signal inputted to the loudspeaker to generate a low-pass filtered voltage signal and a low-pass filtered current signal, respectively; b) calculating a direct-current (DC) resistance of the loudspeaker according to the low-pass filtered voltage signal and the low-pass filtered current signal; c) calculating a vibration velocity of the diaphragm according to the voltage signal, the current signal and the DC resistance; and d) calculating the excursion of the diaphragm according to the vibration velocity. Step (a) to step (d) involve real-number calculations.

### BACKGROUND

1. Field of the Disclosure

The present disclosure relates to a loudspeaker, and more particularly, to a device and a method for calculating excursion of a diaphragm of a loudspeaker and a method for controlling a loudspeaker.

2. Description of Related Art

One criterion in designing a loudspeaker is preventing the loudspeaker from damages when the loudspeaker outputs a large sound. Some main reasons causing damages are excessive vibration of a diaphragm or overheat of a voice coil of the loudspeaker. One possible cause of such excessive vibration of a diaphragm leading to damages in the diaphragm may be that the excursion of the diaphragm (a displacement relative to a still position) exceeds the tolerable range of the diaphragm, or damages in diaphragm are resulted from collisions into other objects due to such excessive excursion. Both of the scenarios above lead to irreversible structural damages in the diaphragm.

Conventionally, there are two general approaches for protecting a diaphragm of a loudspeaker. One is to obtain numerous model parameters of a loudspeaker before measuring the excursion of the diaphragm. However, these parameters involving complex calculations. Further, after using a loudspeaker for an extended period of time, aging of materials may change the model in a way that the original model parameters become no longer applicable. That is, continuing using old model parameters may yield inaccurate measurement values, and expected protection effects cannot be achieved.

In the other approach for protecting a diaphragm of a loudspeaker, an impedance function of a predetermined frequency is obtained according to a voltage and a current, and an input-voltage-to-excursion transfer function associated with the frequency is then obtained according to blocked electrical impedance and a force factor of the loudspeaker. For example, the U.S. Pat. No. 8,942,381, discloses a method for obtaining a time-domain input-voltage-to-excursion transfer function. In the above disclosure, admittance is obtained based on a voltage and a current of a voice coil, and is then incorporated with a delta (A) function, a force factor and blocked electrical impedance to obtain the time-domain input-voltage-to-excursion transfer function. Although requiring less model parameters of a loudspeaker, the above disclosure involves a colossal amount of computation amount, due to several reasons below. First, in addition to being in form of a complex number, the impedance or admittance is associated with the frequency and must be calculated for many frequency components. Secondly, the calculation for the impedance or admittance is complex and involves adaptive filtering. Another reason is that, convolutional operations are required for calculating the excursion of a diaphragm according to impedance or admittance. All of the above reasons cause an extremely complex computation process with a vast computation amount, which indirectly increases the time needed for calculating the excursion as well as chip power consumption.

### SUMMARY

In view of the issues of the prior art, a device and a method for calculating excursion of a diaphragm of a loudspeaker and a method for controlling a loudspeaker are disclosed.

A device for calculating an excursion of a diaphragm of a loudspeaker that comprises a diaphragm and is driven by a voltage signal is disclosed. The device comprising a detection circuit that detects said voltage signal and a current signal inputted to said loudspeaker, a storage unit that stores a plurality of program instructions, and a processing unit that executes said program instructions to perform steps of: a) low-pass filtering said voltage signal and said current signal to generate a low-pass filtered voltage signal and a low-pass filtered current signal, respectively; b) calculating a direct-current (DC) resistance of said loudspeaker according to said low-pass filtered voltage signal and said low-pass filtered current signal; c) calculating a vibration velocity of said diaphragm according to said voltage signal, said current signal and said DC resistance; and d) calculating said excursion of said diaphragm of said loudspeaker according to said vibration velocity. Step (a) to step (d) involve real-number calculations that do not analyze frequency components of said voltage signal and said current signal.

A method for calculating an excursion of a diaphragm of a loudspeaker that comprises a diaphragm and is driven by a voltage signal is disclosed. The method comprising: a) low-pass filtering said voltage signal and a current signal inputted to said loudspeaker to generate a low-pass filtered voltage signal and a low-pass filtered current signal, respectively; b) calculating a direct-current (DC) resistance of said loudspeaker according to said low-pass filtered voltage signal and said low-pass filtered current signal; c) calculating a vibration velocity of said diaphragm according to said voltage signal, said current signal and said DC resistance; and d) calculating said excursion of said diaphragm of said loudspeaker according to said vibration velocity. Step (a) to step (d) involve real-number calculations that do not analyze frequency components of said voltage signal and said current signal.

A method for controlling a loudspeaker, applied to a loudspeaker that comprises a diaphragm and is driven by a voltage signal is disclose. The method comprising: a) low-pass filtering said voltage signal and a current signal inputted to said loudspeaker to generate a low-pass filtered voltage signal and a low-pass filtered current signal, respectively; b) calculating a direct-current (DC) resistance of said loudspeaker according to said low-pass filtered voltage signal and said low-pass filtered current signal; c) calculating a vibration velocity of said diaphragm according to said voltage signal, said current signal and said DC resistance; d) calculating an excursion of said diaphragm of said loudspeaker according to said vibration velocity; and e) adjusting said voltage signal according to said excursion of said diaphragm. Step (a) to step (d) involve real-number calculations that do not analyze frequency components of said voltage signal and said current signal.

The device and method for calculating the excursion of a diaphragm of a loudspeaker and the method for controlling a loudspeaker of the present disclosure are capable of obtaining the excursion of the diaphragm of the loudspeaker simply through real-number calculations. Compared to the prior art, the present disclosure includes real-number calculations that are frequency-independent, and is not required to calculate the impedance or admittance. Hence, the computation amount is significantly reduced.

These and other objectives of the present disclosure no doubt become obvious to those of ordinary skill in the art after reading the following detailed description of the preferred embodiments with reference to the various figures and drawings.

### BRIEF DESCRIPTION OF THE DRAWINGS

FIG. 1 illustrates a functional block diagram of a control circuit for a loudspeaker according to one embodiment of the present disclosure.

FIG. 2 illustrates a circuit model of a loudspeaker according to one embodiment of the present disclosure

FIG. 3 illustrates a block diagram of function modules of a processing unit according to one embodiment of the present disclosure.

FIG. 4 illustrates a flowchart of a method for calculating excursion of a diaphragm of a loudspeaker and for controlling the loudspeaker according to one embodiment of the present disclosure.

FIG. 5 illustrates a flowchart of a method for calculating excursion of a diaphragm of a loudspeaker and for controlling the loudspeaker according to another embodiment of the present disclosure.

FIG. 6 illustrates a flowchart of detailed steps (substeps) of steps S440 or S540.

### DETAILED DESCRIPTION OF THE EMBODIMENTS

The following description is written by referring to terms of this technical field. If any term is defined in this specification, such term should be explained accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

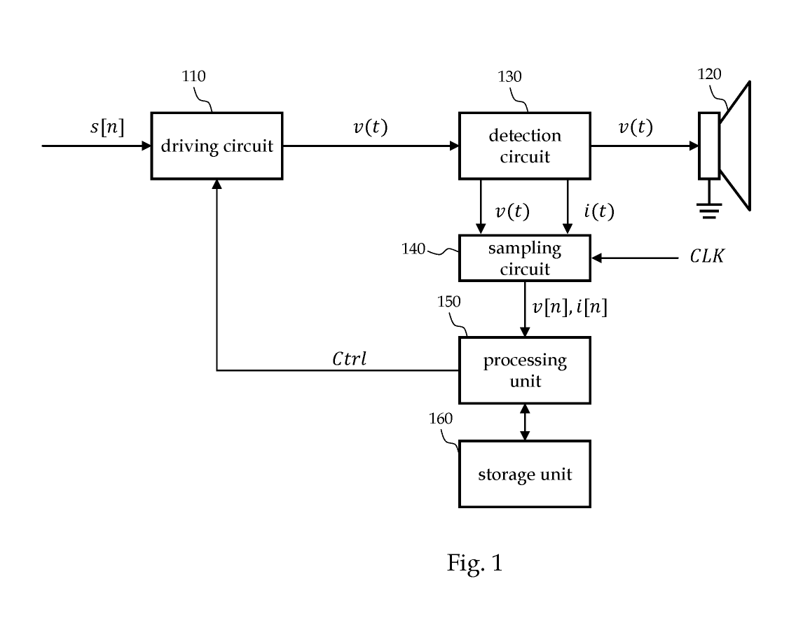

FIG. 1 illustrates a functional block diagram of a control circuit for a loudspeaker according to one embodiment of the present disclosure. Having been processed by a driving circuit 110, an audio signal s[n] becomes a voltage signal v(t) for driving a loudspeaker 120. The driving circuit 110 includes an audio decoder, a digital-to-analog converter (DAC) and an amplifier. The audio decoder decodes the audio signal s[n]. The DAC converts the decoded signal corresponding to the audio signal s[n] from a digital format to an analog format. The amplifier controls the amplitude of the voltage signal v(t) according to a gain. In response to changes in the frequency and the amplitude of the voltage signal v(t), the current passing through a voice coil of the loudspeaker 120 is also changed. The change in the current on the voice coil and a magnetic field of a permanent magnet of the loudspeaker 120 interact to move the voice coil, in a way that the diaphragm of the loudspeaker 120 is driven to vibrate.

In some embodiments, the measurement of the voltage signal v(t) is not limited to measuring the voltage at an input of the loudspeaker 120 using the detection circuit 130, and may also be predicted or estimated based on the audio signal s[n] and the gain of the amplifier.

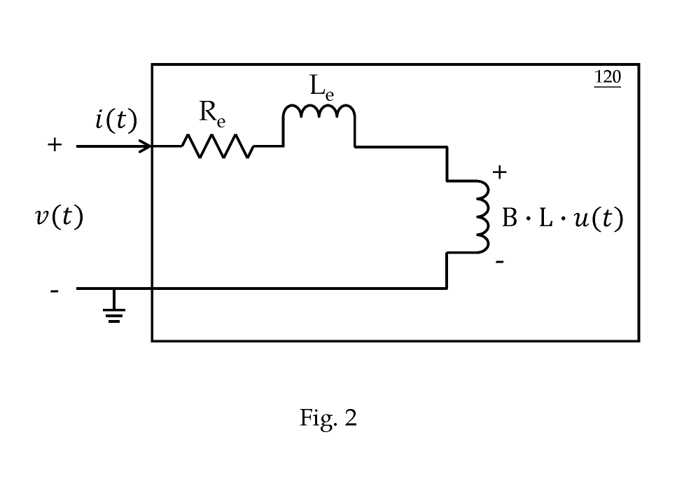

FIG. 2 illustrates a circuit model of the loudspeaker 120 according to one embodiment of the present disclosure The circuit model of the loudspeaker 120 includes a resistance Rₑ, an inductance Lₑ and a back electromotive force (EMF) B·L·u(t) generated in response to the diaphragm vibration (i.e., the displacement of the voice coil), in which B is the magnetic flux of the permanent magnet of the loudspeaker 120, L is the length of the voice coil, and u(t) is a vibration velocity of the diaphragm. The product of the magnetic flux B and the voice coil length L is a force factor of the loudspeaker 120, and is a constant value. Further, v(t) is the voltage signal that drives the loudspeaker 120, and the corresponding current signal i(t) passes these three components. According to the Kirchhoff's voltage law, an equation below is obtained:

$$v ( t ) = {R}_{e} \cdot i ( t ) + {L}_{e} \cdot \frac{di}{dt} + B \cdot L \cdot u ( t ) \qquad ( 1 )$$

Equations (2) and (3) are further obtained from equation (1):

$$\begin{matrix}B \cdot L \cdot u ( t ) = v ( t ) - {R}_{e} \cdot i ( t ) - {L}_{e} \cdot \frac{di}{dt} & ( 2 ) \\ u ( t ) = \frac{1}{BL} [ v ( t ) - {R}_{e} \cdot i ( t ) - {L}_{e} \cdot \frac{di}{dt} ] & ( 3 )\end{matrix}$$

Equation (2) is an expression of the back EMF generated in response to the diaphragm vibration, and equation (3) is an expression of the vibration velocity u(t) of the diaphragm. It is obvious that the ratio of the back EMF B·L·u(t) to the vibration velocity u(t) of the diaphragm is a constant value (i.e., the force factor of the loudspeaker 120); thus calculating one of the back EMF B·L·u(t) and the vibration velocity u(t) is substantially equivalent to calculating the other. The mechanism which the present disclosure uses to calculate the excursion of the diaphragm is illustrated below through an example of calculating the vibration velocity u(t) of the diaphragm.

For a small-sized loudspeaker, the effect caused by inductance impedance jωLₑ is far smaller than that caused by the resistance Rₑ. Thus, the effect of the inductance may be omitted, i.e.,

$${L}_{e} \cdot \frac{di}{dt}$$

in equation (3) is omitted, and the vibration velocity u(t) of the diaphragm in equation (3) is approximately:

$$u ( t ) = \frac{1}{BL} [ v ( t ) - {R}_{e} \cdot i ( t ) ] \qquad ( 4 )$$

By integrating the vibration velocity u(t) with respect to time t, the excursion x(t) of the diaphragm is obtained:

$$x ( t ) = \int \frac{1}{BL} [ v ( t ) - {R}_{e} \cdot i ( t ) ] dt \qquad ( 5 )$$

The following shows how the present disclosure practices equation (5) to obtain the excursion x(t) of the diaphragm of the loudspeaker 120. Referring back to FIG. 1, the present disclosure adopts the detection circuit 130, the sampling circuit 140, the processing unit 150 and the storage unit 160 to practice equation (5). The detection circuit 130, coupled between the driving circuit 110 and the loudspeaker 120, detects the voltage signal v(t) and the current signal i(t). For example, in order to detect the voltage signal v(t), the detection circuit 130 may measure the voltage at the input of the loudspeaker 120 to learn the voltage signal v(t). On the other hand, in order to detect the current signal i(t), a resistor may be included in the detection circuit 130, and the current signal i(t) may be learned according to a cross voltage and a resistance of the resistor. After the voltage signal v(t) and the current signal i(t) are sampled by the sampling circuit 140 (sampled according to a sampling clock CLK having a clock cycle T), discrete-time signals v[n] and i[n] corresponding to the voltage signal v(t) and the current signal i(t) are generated (where n is an integer) for the processing unit 150 to perform subsequent operations.

The processing unit 150 is a logic circuit, e.g., a microprocessor, a microcontroller unit (MCU) or a central processing unit (CPU), with capabilities for executing program codes, commands or program instructions. These program codes, commands or program instructions are stored in the storage unit 160, and implement the operation principles and/or algorithms of the present disclosure. The processing unit 150 executes these program codes, commands or program instructions to realize the mechanism of the present disclosure. In addition to the above program codes, commands and program instructions, the storage unit 160 further stores some parameters, e.g., the force factor of the loudspeaker 120.

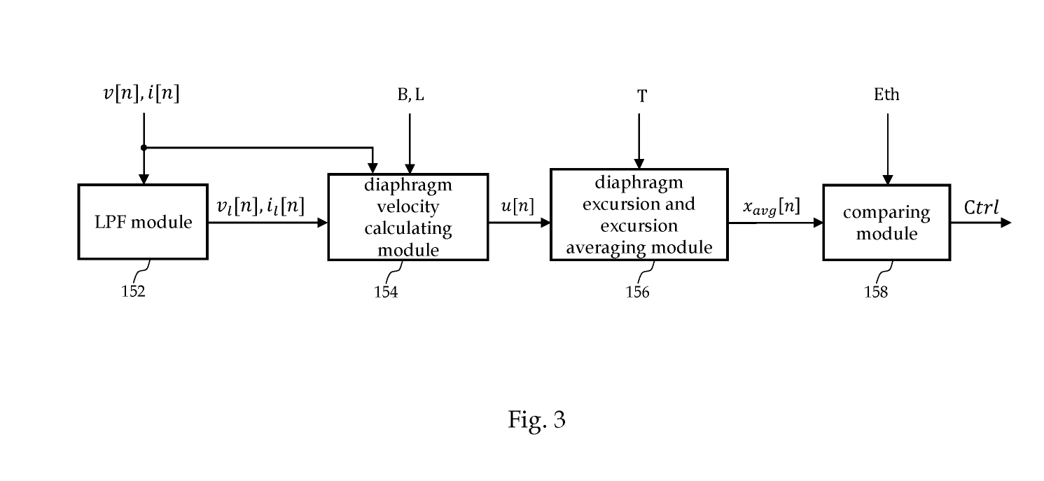

There may be multiple function modules based on the functions of the program codes, commands or program instructions. The processing unit 150 performs these program codes, commands or program instructions to realize the functions of the modules. FIG. 3 illustrates a block diagram of function modules of a processing unit 150 according to one embodiment of the present disclosure. The processing circuit 150 includes a low-pass filtering (LPF) module 152, a diaphragm velocity calculating module 154, a diaphragm excursion and excursion averaging module 156, and a comparing module 158.

In some embodiments, at least one of the LPF module 152, the diaphragm velocity calculating module 154, the diaphragm excursion and excursion averaging module 156, and the comparing module 158 may be implemented by an application-specific integrated circuit (ASIC).

The LPF module 152 low-pass filters the voltage signal v[n] and the current signal i[n] to generate a low-pass filtered voltage signal vₗ[n] and a low-pass filtered current signal iₗ[n]. The diaphragm velocity calculating module 154 calculates the resistance Rₑ in equation (5) according to the low-pass filtered voltage signal vₗ[n] and the low-pass filtered current signal iₗ[n]. Actually, the voltage signal v(t) not only corresponds to the audio signal s[n] but also includes a low-frequency signal. Derived from the voltage signal v(t), the voltage signal v[n] and the low-pass filtered voltage signal vₗ[n] both include the low-frequency signal as well. The frequency of the low-frequency signal is lower than the lower limit of the human ear audible frequency range (20 Hz), and thus does not impose any effect on a listener. Further, as the impedance measured based on the low-frequency signal approximates the value of the DC resistance Rₑ, the DC resistance Rₑ can be obtained, based on the Ohms' law, according to the low-pass filtered voltage signal vₗ[n] and the low-pass filtered current signal iₗ[n].

One main purpose of the diaphragm velocity calculating module 154 is implementing equation (4) to obtain the vibration velocity u(t) of the diaphragm. Take the discrete-time domain for example. The diaphragm velocity calculating module 154 first obtains the value of the DC resistance Rₑ according to the low-pass filtered voltage signal vₗ[n] and the low-pass filtered current signal iₜ[n]. More specifically, the diaphragm velocity calculating module 154 first obtains respective temporal averages of the low-pass filtered voltage signal vₗ[n] and the low-pass filtered current signal iₗ[n], e.g., arithmetic averages, geometric averages, exponential averages, or root mean squares (RMS). Taking the RMS for example, vₗ_{_}ᵣₘₛ[n] and iₗ_{_}ᵣₘₛ[n] are respectively obtained, and the resistance Rₑ is then calculated, e.g., Rₑ=vₗ_{_}ᵣₘₛ[n]/iₗ_{_}ᵣₘₛ[n]. After obtaining Rₑ, the diaphragm velocity calculating module 154 calculates the product of the resistance Rₑ and the current signal i[n], and divides the result of subtracting the product from the voltage signal v[n] by the force factor B·L to obtain the vibration velocity u[n] of the diaphragm.

Based on the equation (4) and the above description, as the constant B·L, and the variables v[n], i[n], vₗ[n] and i[n] are all real numbers, the calculation which the diaphragm velocity calculating module 154 performs involves only real numbers instead of imaginary numbers. Further, although the voltage signal v[n] and the current signal i[n] include many frequency components, the diaphragm velocity calculating module 154 does not need to analyze these frequency components (e.g., calculating impedance or admittance of respective frequency components). Therefore, compared to the prior art, the diaphragm velocity calculating module 154 does not need adaptive filtering operations, and so the computation complexity can be significantly reduced.

The diaphragm excursion and excursion averaging module 156 calculates the excursion x[n] of the diaphragm according to the vibration velocity u[n] of the diaphragm. According to equation (5), the vibration velocity u[n] is multiplied by the cycle T of the sampling clock, and then the products corresponding to sequential indices n are added up to obtain the excursion of the diaphragm, i.e., x[n]=Σu[n]·T. The average value of the excursion x[n] is then obtained according to equation (6) below:

x_{avg}[n]=α·x_{avg}[n−1]+(1−α)·x[n] (6)

Equation (6) is an exponential average calculation. The current average x_{avg}[n] is equivalently the previous average x_{avg}[n−1] multiplied by a weight a (0<α<1) and then added with the current excursion x[n] multiplied by a weight (1−α). Because the excursion x[n] is a real number, equation (6) is also a real-number calculation that does not involve any imaginary numbers, meaning that the diaphragm excursion and excursion averaging module 156 can quickly obtain the average x_{avg}[n] of the diaphragm through performing less complex calculations. It should be noted that, the method adopted by the diaphragm excursion and excursion averaging module 156 is not limited to equation (6), and other averaging methods, e.g., arithmetic average, geometric average and root mean square methods (equation (7)), are also applicable to the present disclosure.

x_{avg}[n]=\sqrt{x²[n]+α·(x_{avg}²[n−1]−x²[n])} (7)

The comparing module 158 compares the average x_{avg}[n] of the excursion with a threshold Eth (stored in the storage unit 160). When the average excursion x_{avg}[n] is greater than the threshold Eth, it means that the excursion of the diaphragm has been excessively large for a long time, which may lead to mechanical fatigue or damages of the diaphragm. Thus, the comparing module 158 outputs a control signal Ctrl to control the driving circuit 110 to reduce the gain of the amplifier.

In the embodiments above, the diaphragm is protected based on the average excursion of the diaphragm. In other embodiments, the diaphragm excursion and excursion averaging module 156 and the comparing module 158 may also protect the loudspeaker 120 based on an instantaneous peak value of the excursion of the diaphragm (e.g., calculating a peak value of the excursion of the diaphragm), so as to prevent the diaphragm from colliding with the casing of the loudspeaker 120 and hence from damages when the excursion of the diaphragm is excessively large. Similarly, when the instantaneous peak value of the excursion of the diaphragm is greater than the threshold, the processing unit 150 may control the driving circuit 110 to reduce the gain of the amplifier.

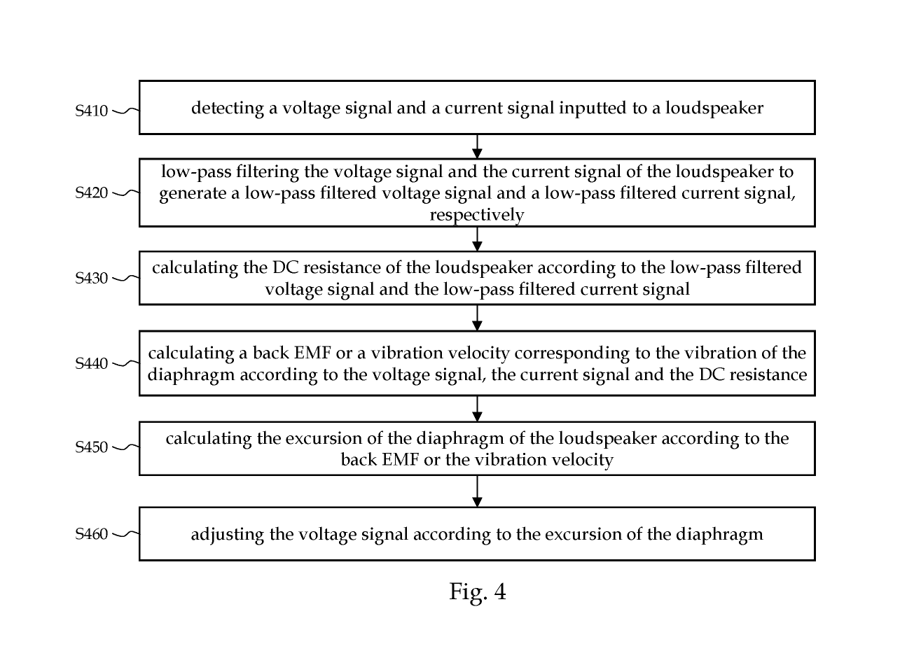

In addition to the device for calculating the excursion of a diaphragm of a loudspeaker, the present disclosure further discloses a method for calculating excursion of a diaphragm of a loudspeaker and for controlling the loudspeaker. Referring to FIG. 4 showing a flowchart of the method according to an embodiment of the present disclosure, the method includes the following steps.

In step S410, a voltage signal and a current signal inputted to the loudspeaker are detected. The current signal is associated with the voltage signal that drives the loudspeaker. In practice, a current detector may be coupled between the loudspeaker and a driving circuit of the loudspeaker to detect the current signal.

In step S420, the voltage signal and the current signal of the loudspeaker are low-pass filtered to generate a low-pass filtered voltage signal and a low-pass filtered current signal, respectively. To obtain the DC resistance of a resistor of the loudspeaker, the driving circuit adds a low-frequency component (having a frequency lower than the lower limit of the audible range to the human ear) to the voltage signal. The purpose of this step is to obtain this low-frequency signal.

In step S430, the DC resistance of the loudspeaker is calculated according to the low-pass filtered voltage signal and the low-pass filtered current signal. The ratio of the low-pass filtered voltage signal to the low-pass filtered current signal is the DC resistance of the loudspeaker. Before calculating the ratio between the two, this step may first obtain temporal averages of the low-pass filtered voltage signal and the low-pass filtered current signal, e.g., root mean squares, to obtain more accurate DC resistance. Because the low-pass filtered voltage signal and the low-pass filtered current signal are both real numbers, this step is a real-number calculation, and so the DC resistance obtained is also a real number.

In step S440, a back EMF or a vibration velocity corresponding to the vibration of the diaphragm is calculated according to the voltage signal, the current signal and the DC resistance. With the voltage signal, the current signal and the DC resistance of the loudspeaker, the vibration velocity of the diaphragm of the loudspeaker can be calculated according to equation (4) (equivalently calculating the back EMF of the loudspeaker, as a ratio between the two being a constant value). Because the voltage signal, the current signal and the DC resistance are all real numbers, this step is a real-number calculation, and so the back EMF or the vibration velocity obtained is also a real number.

In step S450, the excursion of the diaphragm of the loudspeaker is calculated according to the back EMF or the vibration velocity. In this step, the excursion of the diaphragm is calculated according to equation (5); that is, the vibration velocity obtained in step S440 is multiplied by the sampling cycle of the voltage/current signal and then the sequential products are added up, hence obtaining the excursion of the diaphragm.

In step S460, the voltage signal is adjusted according to the excursion of the diaphragm. After the excursion of the diaphragm is obtained, a peak measurement or a calculation of an average value (e.g., an exponential average or a root mean square (RMS)) can be performed on the excursion of the diaphragm. According to the result of the peak measurement and/or the calculation of the average value, the voltage signal is adjusted (e.g., through adjusting the gain of the driving circuit) to protect the loudspeaker.

Since the calculations in steps S410 to S460 involve only calculations of real numbers but not imaginary numbers, and the present disclosure does not analyze the frequency components of the voltage signal and the current signal, the computation complexity is significantly reduced and the calculation time is reduced compared to the conventional method of calculating the impedance or admittance of the loudspeaker. Therefore, for the same hardware processing speed, with the low computation complexity of the present disclosure, information on the excursion of the diaphragm can be obtained more instantly.

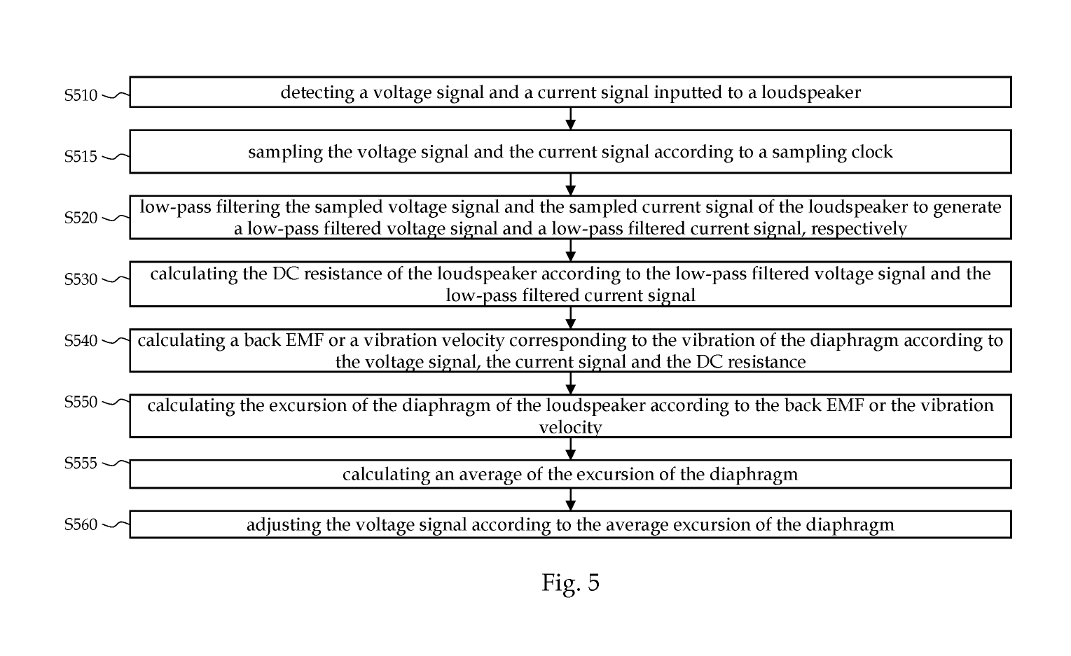

FIG. 5 shows a flowchart of a method for calculating excursion of a diaphragm of a loudspeaker and for controlling the loudspeaker according to another embodiment of the present disclosure. Compared to step S410, the voltage signal and the current signal in step S510 are further defined as analog signals. In step S515, the voltage signal and the current signal are sampled according to a sampling clock to generate a sampled voltage signal and a sampled current signal. Step S520 is similar to step S420, except that in step S520 the low-pass filtering process is performed on the sampled voltage signal and the sampled current signal. Steps S530˜S550 are the same as steps S430˜S450. In step S555, the excursion of the diaphragm is averaged to further ensure that step S560, which is the same as step S460, is performed based on a more reliable result.

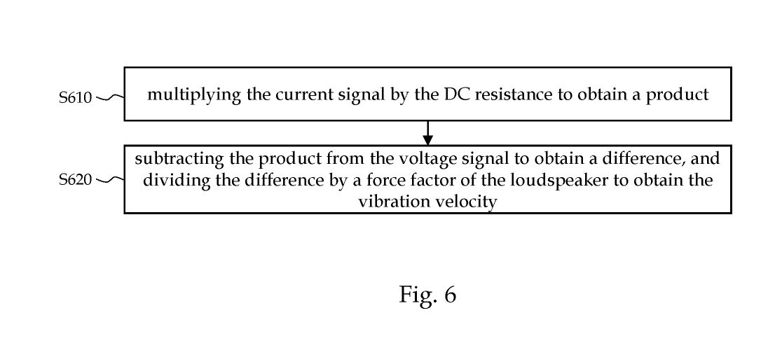

FIG. 6 shows a flowchart of detailed steps of steps S440 or S540. In step S610, the current signal is multiplied by the DC resistance to obtain a product. In step S620, the product is subtracted from the voltage signal to obtain a difference, and then the difference is divided by the loudspeaker force factor to obtain the vibration velocity.

Since people of ordinary skill in the art can appreciate the implementation detail and the modification thereto of the method disclosure of FIG. 4 to FIG. 6 through the device disclosure of FIG. 1 to FIG. 3, repeated and redundant description is thus omitted. Please note that there is no step sequence limitation for the method disclosure s as long as the execution of each step is applicable. Furthermore, the shape, size, and ratio of any element and the step sequence of any flow chart in the disclosed figures are exemplary for understanding, not for limiting the scope of this disclosure.

The aforementioned descriptions represent merely the preferred embodiments of the present disclosure, without any intention to limit the scope of the present disclosure thereto. Various equivalent changes, alterations, or modifications based on the claims of the present disclosure are all consequently viewed as being embraced by the scope of the present disclosure.

What is claimed is:

1. A device for calculating an excursion of a diaphragm of a loudspeaker that comprises a diaphragm and is driven by a voltage signal, said device comprising:
a detection circuit, detecting said voltage signal and a current signal inputted to said loudspeaker;
a storage unit, storing a plurality of program instructions; and
a processing unit, executing said program instructions to perform steps of:
a) low-pass filtering said voltage signal and said current signal to generate a low-pass filtered voltage signal and a low-pass filtered current signal, respectively;
b) calculating a direct-current (DC) resistance of said loudspeaker according to said low-pass filtered voltage signal and said low-pass filtered current signal;
c) calculating a vibration velocity of said diaphragm according to said voltage signal, said current signal and said DC resistance; and
d) calculating said excursion of said diaphragm of said loudspeaker according to said vibration velocity;
wherein, step (a) to step (d) involve a real-number calculation.

2. The device according to claim 1, wherein step (c) comprises:
c1) multiplying said current signal by said DC resistance to obtain a product; and
c2) subtracting said product from said voltage signal to obtain a difference, and dividing said difference by a force factor of said loudspeaker to obtain said vibration velocity.

3. The device according to claim 1, further comprising:
a sampling circuit, coupled to said processing unit, sampling said voltage signal and said current signal according to a sampling clock to generate a sampled voltage signal and a sampled current signal, respectively;
wherein, said processing unit processes said sampled voltage signal and said sampled current signal, and step (d) multiplies said vibration velocity by a cycle of said sampling clock and adds up sequential products to obtain said excursion of said diaphragm.

4. The device according to claim 1, wherein said processing unit further executes said program instructions to perform a step of:
e) calculating an average of said excursion of said diaphragm by an average calculation.

5. The device according to claim 4, wherein said average calculation first calculates a first product of a previous average and a first weight and then calculates a second product of said excursion of said diaphragm and a second weight, a sum of said first product and said second product is said average, and a sum of said first weight and said second weight is one.

6. The device according to claim 1, wherein a product of said vibration velocity and a force factor of said loudspeaker is equal to a back electromagnetic force (EMF) generated by vibrations of said diaphragm.

7. A method for calculating an excursion of a diaphragm of a loudspeaker that comprises a diaphragm and is driven by a voltage signal, said method comprising:
a) low-pass filtering said voltage signal and a current signal inputted to said loudspeaker to generate a low-pass filtered voltage signal and a low-pass filtered current signal, respectively;
b) calculating a direct-current (DC) resistance of said loudspeaker according to said low-pass filtered voltage signal and said low-pass filtered current signal;
c) calculating a vibration velocity of said diaphragm according to said voltage signal, said current signal and said DC resistance; and
d) calculating said excursion of said diaphragm of said loudspeaker according to said vibration velocity;
wherein, step (a) to step (d) involve a real-number calculation.

8. The method according to claim 7, wherein step (c) comprises:
c1) multiplying said current signal by said DC resistance to obtain a product; and
c2) subtracting said product from said voltage signal to obtain a difference, and dividing said difference by a force factor of said loudspeaker to obtain said vibration velocity.

9. The method according to claim 7, further comprising:
e) sampling said voltage signal and said current signal according to a sampling clock to generate a sampled voltage signal and a sampled current signal, respectively;
wherein, step (a) to step (d) process said sampled voltage signal and said sampled current signal, and step (d) multiplies said vibration velocity by a cycle of said sampling clock and adds up sequential products to obtain said excursion of said diaphragm.

10. The method according to claim 7, further comprising:
e) calculating an average of said excursion of said diaphragm by an average calculation.

11. The method according to claim 10, wherein said average calculation first calculates a first product of a previous average and a first weight and then calculates a second product of said excursion of said diaphragm and a second weight, a sum of said first product and said second product is said average, and a sum of said first weight and said second weight is one.

12. The method according to claim 7, wherein a product of said vibration velocity and a force factor of said loudspeaker is equal to a back electromagnetic force (EMF) generated by vibrations of said diaphragm.

13. A method for controlling a loudspeaker, applied to a loudspeaker that comprises a diaphragm and is driven by a voltage signal, said method comprising:
a) low-pass filtering said voltage signal and a current signal inputted to said loudspeaker to generate a low-pass filtered voltage signal and a low-pass filtered current signal, respectively;
b) calculating a direct-current (DC) resistance of said loudspeaker according to said low-pass filtered voltage signal and said low-pass filtered current signal;
c) calculating a vibration velocity of said diaphragm according to said voltage signal, said current signal and said DC resistance;
d) calculating an excursion of said diaphragm of said loudspeaker according to said vibration velocity; and
e) adjusting said voltage signal according to said excursion of said diaphragm;
wherein, step (a) to step (d) involve a real-number calculation.

14. The method according to claim 13, wherein step (c) comprises:
c1) multiplying said current signal by said DC resistance to obtain a product; and
c2) subtracting said product from said voltage signal to obtain a difference, and dividing said difference by a force factor of said loudspeaker to obtain said vibration velocity.

15. The method according to claim 13, further comprising:
f) sampling said voltage signal and said current signal according to a sampling clock to generate a sampled voltage signal and a sampled current signal, respectively;
wherein, step (a) to step (e) process said sampled voltage signal and said sampled current signal, and step (d) multiplies said vibration velocity by a cycle of said sampling clock and adds up sequential products to obtain said excursion of said diaphragm.

16. The method according to claim 13, further comprising:
f) calculating an average of said excursion of said diaphragm by an average calculation.

17. The method according to claim 16, wherein said average calculation first calculates a first product of a previous average and a first weight and then calculates a second product of said excursion of said diaphragm and a second weight, a sum of said first product and said second product is said average, and a sum of said first weight and said second weight is one.

18. The method according to claim 13, wherein a product of said vibration velocity and a force factor of said loudspeaker is equal to a back electromagnetic force (EMF) generated by vibrations of said diaphragm.
